(19) United States
(12) Patent Application Publication
(10) Pub. No.: US 2005/0178047 A1
(43) Pub. Date: Aug. 18, 2005

(54) Rodent trap

(76) Inventor: Solomon Aguillera, Brooklyn, NY (US)

Correspondence Address: ASHKAN NAJAFI, P.A., 6817 SOUTHPOINT PARKWAY, SUITE 2301, JACKSONVILLE, FL, 32216, US

(21) Appl. No.: 10/776,048

(22) Filed: Feb. 12, 2004

(51) Int. Cl. A01M 23/18

(52) U.S. Cl. 43/61

(57) ABSTRACT

A rodent trap includes a cage and a cavity therein. The cage includes oppositely spaced end portions having a plurality of apertures for defining an entrance path respectively. The cage further includes a top surface having an aperture formed therein. The cage further includes a bottom surface including a door pivotally attached to the cage for allowing a user to access rodents trapped within the cage. The cage further includes a plurality of trap doors pivotally connected to the cage and adjacent the opposed end portions for causing rodents to enter the cavity and become trapped therein as the rodents move towards the bait. The plurality of trap doors includes a plurality of outer end portions and a plurality of spring members so that the plurality of trap doors will pivot downwardly. The plurality of trap doors thereafter pivot upwardly to a resting position after rodents enter the cavity

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to animal traps and, more particularly, to a rodent trap for safely and effectively eradicating rodents.

2. Prior Art

Although there are numerous examples in the prior art of inventors attempting to “build a better mousetrap,” many disclosed rodent trap patents, while effective, have problems that render them less than desirable to many users. As an example, some rodent traps use poison as bait that a rodent eats. This type of trap requires the poison to be placed in a position where a rodent can easily access it in order to consume it. If a rodent can access the poison, then it is quite possible that a naturally curious infant, small child or pet crawling on a floor might also access the poison and consume it, with potentially harmful consequences.

Other common rodent traps use a powerful spring loaded lever that clamps about a rodent's neck when triggered, thereby suffocating the rodent. Again, these traps allow easy access by a rodent, and thus, an infant or pet could also get a hand or paw entrapped under the spring loaded lever, causing pain and anxiety.

Other common rodent traps use a sticky adhesive for de-mobilizing a rodent until a user comes along and picks up the trap and disposes of it. Again, a small infant or pet could also get an appendage or other body part stuck on such trap potentially causing injury.

Because many rodents carry infectious diseases, it is preferable to use a trap where the user has no physical contact with the captured rodent. This scenario does not always occur with the traps noted above. In order to avoid such contact, a preferred rodent trap would surround a rodent with a cage or other containment apparatus in order to separate the rodent from a user.

Accordingly, a need remains for an apparatus that confines an entrapped rodent in a cage without using poison as bait or spring loaded levers for eradication.

### BRIEF SUMMARY OF THE INVENTION

In view of the foregoing background, it is therefore an object of the present invention to provide an apparatus for attracting and holding rodents within a confined area. These and other objects, features, and advantages of the invention are provided by a trap including a cage formed from durable material and having a cavity sufficient for holding a plurality of rodents therein. The cage is formed from wire mesh material and includes oppositely spaced end portions having a plurality of apertures formed therein for defining an entrance path into the cage respectively.

The cage further includes a top surface having an aperture formed therein for defining a path through which bait may be deposited into the cage. The bait path defined by the top surface aperture is disposed in a substantially vertical direction medially of the opposed end portions of the cage so that bait can be positioned between the entrance paths. The cavity is disposed below the entrance paths so that rodents cannot escape from the cavity after entering therein.

The cage further includes a bottom surface including a door pivotally attached to the cage for allowing a user to access rodents trapped within the cage. The cage further includes a plurality of trap doors pivotally connected to the cage and adjacent the opposed end portions for causing rodents to enter the cavity and become trapped therein as the rodents move towards the bait. A plurality of handles are secured to the cage for assisting a user to transport same between remote locations.

The plurality of trap doors includes a plurality of outer end portions and a plurality of spring members for connecting the plurality of outer end portions to the cage so that as rodents enter the apparatus through the entrance paths and move inwardly towards the bait, the plurality of trap doors will pivot downwardly about the plurality of outer end portions thereof. The plurality of trap doors thereafter pivot upwardly to a resting position after rodents enter the cavity. A plurality of stop members are connected to the cage adjacent the plurality of trap doors for preventing same from pivoting upwardly beyond a resting position.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a perspective view showing an apparatus for attracting and holding rodents in a confined area, in accordance with the present invention;

FIG. 2 is a cross-sectional view of the apparatus shown in FIG. 1, taken along line 2-2;

FIG. 3 is a cross-sectional view of the apparatus shown in FIG. 1, taken along line 3-3; and

FIG. 4 is a cross-sectional view of the apparatus shown in FIG. 2, taken along line 4-4.

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. Like numbers refer to like elements throughout the figures.

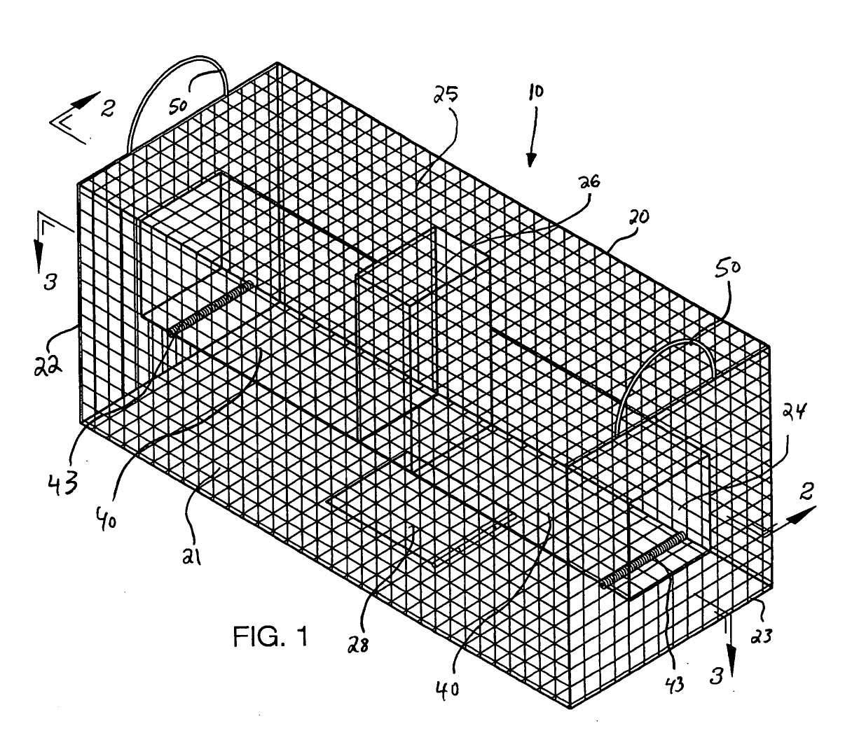

The apparatus of this invention is referred to generally in FIGS. 1-4 by the reference numeral 10 and is intended to attract and hold rodents within a confined area. It should be understood that the trap 10 may be used to attract and hold many different types of small animals and should not be limited to only rodents.

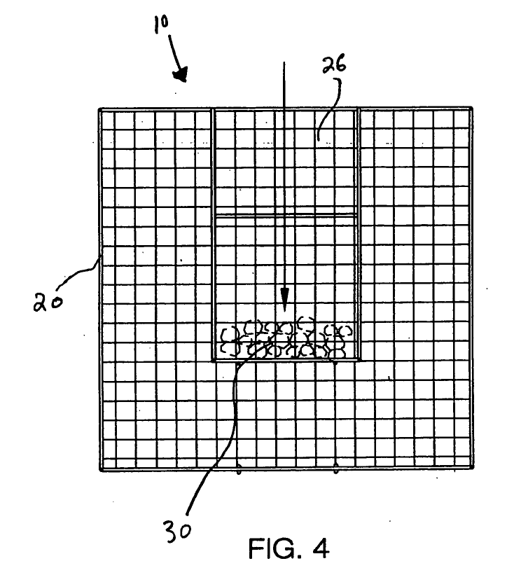

Initially referring to FIG. 1, the trap 10 includes a cage 20 preferably formed from lightweight, durable material such as wire mesh and having a cavity 21 sufficient for holding a plurality of rodents therein. Advantageously, wire mesh is both strong and lightweight, enabling a user to ascertain the contents of the cage 20 without opening it. Captured rodents are thus easily transported in the cage 20 to a remote location for eradication. The cage 20 includes oppositely spaced end portions 22, 23 having a plurality of apertures 24 formed therein for defining an entrance path into the cage 20 respectively. The cage 20 further includes a top surface 25 having an aperture 26 formed therein for defining a path through which bait 30 may be deposited into the cage 20, as perhaps best shown in FIG. 4.

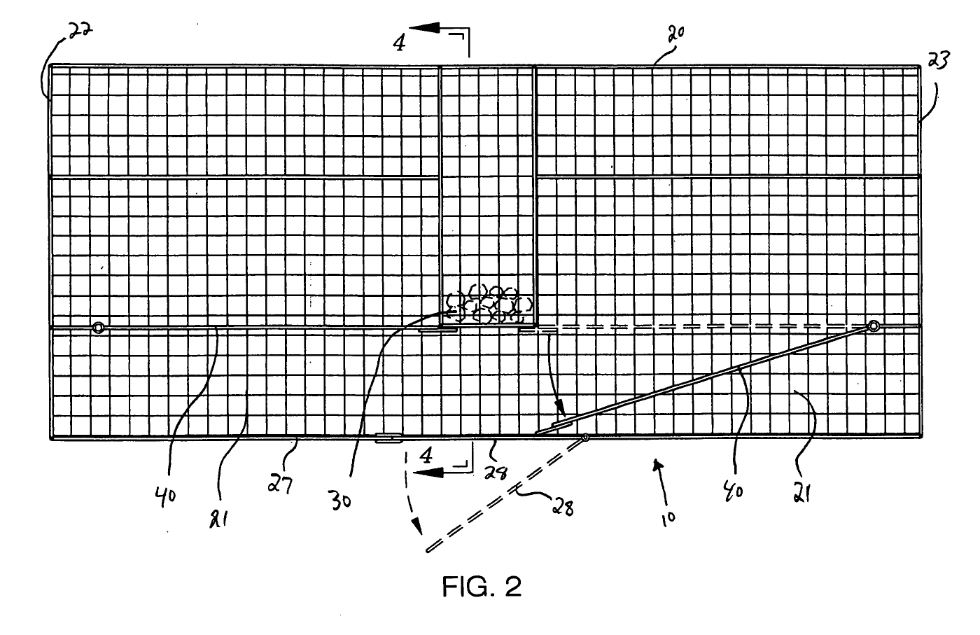

The bait path defined by the top surface aperture 26 is disposed in a substantially vertical direction medially of the opposed end portions 22, 23 of the cage 20 so that bait 30 can be positioned between the entrance paths, as perhaps best shown in FIG. 2. The medial position of the bait 30 draws the rodents into the cage 20 where they subsequently become trapped. The cavity 21 is disposed below the entrance paths so that rodents cannot exit the cavity 21 after entering therein, as again best shown in FIG. 2.

Now referring to FIG. 2, the cage 20 further includes a bottom surface 27 including a door 28 pivotally attached to the cage 20 for allowing a user to access rodents trapped within the cage 20. Because the cage 20 traps its occupants alive, scientists or other interested parties may use the trapped animals for testing or lab experiments if so desired. The cage 20 further includes a plurality of trap doors 40 pivotally connected to the cage 20 and adjacent the opposed end portions 22, 23 for causing rodents to enter the cavity 21 and become trapped therein as the rodents move towards the bait 30. A plurality of handles 50 are secured to the cage 20 for assisting a user to transport same between remote locations, as best shown in FIG. 1.

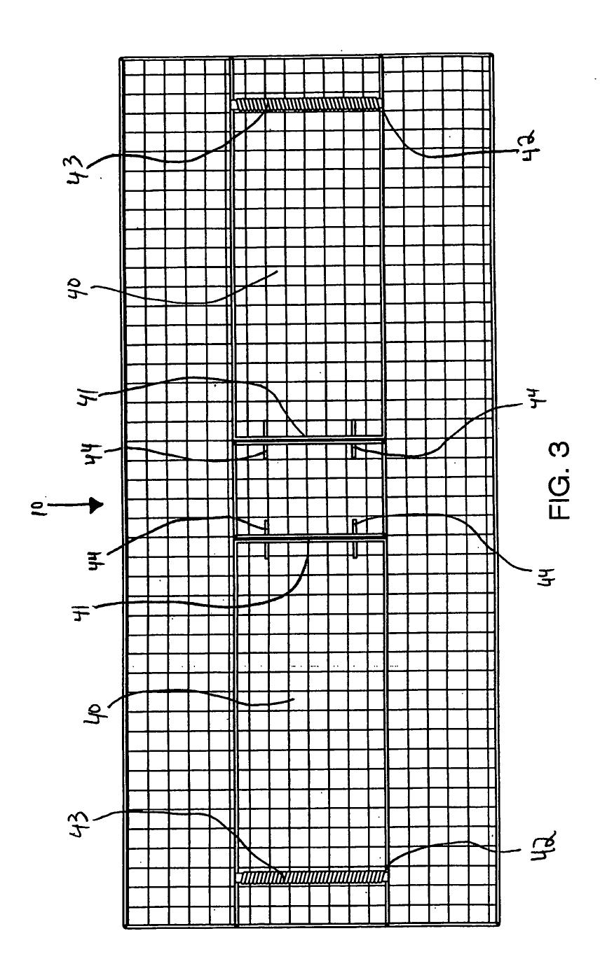

Now referring to FIG. 3, the plurality of trap doors 40 includes a plurality of outer end portions 41, 42 and a plurality of spring members 43 for connecting the plurality of outer end portions 41, 42 to the cage 20 so that as rodents enter the trap 10 through the entrance paths and move inwardly towards the bait 30, the plurality of trap doors 40 will pivot downwardly about the plurality of outer end portions 41, 42 thereof, as best shown in FIG. 2.

As the rodents move towards the bait 30, their own weight causes the plurality of trap doors 40 to pivot downwardly so that a rodent slides downwardly into the cavity 21. The plurality of trap doors 40 thereafter pivot upwardly to a resting position after rodents enter the cavity 21, thereby preventing trapped rodents from exiting the cavity 21. A plurality of stop members 44 are connected to the cage 20 adjacent the plurality of trap doors 40 for preventing same from pivoting upwardly beyond a resting position.

The trap 10 eliminates the need for poison or spring loaded levers to eradicate rodents making it safe to use around small children and household pets. Its lightweight, durable structure provides a fast, reliable and cost effective way of capturing rodents. The wire mesh increases visibility and enables a user to quickly ascertain the number of rodents, if any, trapped therein.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention.

In particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

1. An apparatus for attracting and holding rodents within a confined area, said apparatus comprising;
a cage formed from durable material and having a cavity sufficient for holding a plurality of rodents therein, said cage including oppositely spaced end portions having a plurality of apertures formed therein for defining an entrance path into said cage respectively, said cage further including a top surface having an aperture formed therein for defining a path through which bait may be deposited into said cage, said cage further including a bottom surface including a door pivotally attached to said cage for allowing a user to access rodents trapped within said cage, said cage further including a plurality of trap doors pivotally connected to said cage and adjacent said opposed end portions for causing rodents to enter the cavity and become trapped therein as the rodents move towards the bait.

2. The apparatus of claim 1, wherein said plurality of trap doors comprise:
a plurality of outer end portions;
a plurality of spring members for connecting said plurality of outer end portions to said cage so that as rodents enter said apparatus through the entrance paths and move inwardly towards the bait said plurality of trap doors will pivot downwardly about said plurality of outer end portions thereof and thereafter pivot upwardly to a resting position after rodents enter the cavity; and
a plurality of stop members connected to said cage adjacent said plurality of trap doors and for preventing same from pivoting upwardly beyond a resting position.

3. The apparatus of claim 1, wherein the bait path defined by the top surface aperture is disposed in a substantially vertical direction medially of said opposed end portions of said cage so that bait can be positioned between the entrance paths.

4. The apparatus of claim 1, wherein the cavity is disposed below the entrance paths so that rodents cannot escape from the cavity after entering therein.

5. The apparatus of claim 1, further comprising:
a plurality of handles secured to said cage for assisting a user to transport same between remote locations.

6. The apparatus of claim 1, wherein said cage is formed from wire mesh material.

7. An apparatus for attracting and holding rodents within a confined area, said apparatus comprising:
a cage formed from durable material and having a cavity sufficient for holding a plurality of rodents therein, said cage including oppositely spaced end portions having a plurality of apertures formed therein for defining an entrance path into said cage respectively, said cage further including a top surface having an aperture formed therein for defining a path through which bait may be deposited into said cage, said cage further including a bottom surface including a door pivotally attached to said cage for allowing a user to access rodents trapped within said cage, said cage further including a plurality of trap doors pivotally connected to said cage and adjacent said opposed end portions for causing rodents to enter the cavity and become trapped therein as the rodents move towards the bait, said plurality of trap doors comprising
a plurality of outer end portions;
a plurality of spring members for connecting said plurality of outer end portions to said cage so that as rodents enter said apparatus through the entrance paths and move inwardly towards the bait said plurality of trap doors will pivot downwardly about said plurality of outer end portions thereof and thereafter pivot upwardly to a resting position after rodents enter the cavity; and
a plurality of stop members connected to said cage adjacent said plurality of trap doors and for preventing same from pivoting upwardly beyond a resting position.

8. The apparatus of claim 7, wherein the bait path defined by the top surface aperture is disposed in a substantially vertical direction medially of said opposed end portions of said cage so that bait can be positioned between the entrance paths.

9. The apparatus of claim 7, wherein the cavity is disposed below the entrance paths so that rodents cannot escape from the cavity after entering therein.

10. The apparatus of claim 7, further comprising:
a plurality of handles secured to said cage for assisting a user to transport same between remote locations.

11. The apparatus of claim 7, wherein said cage is formed from wire mesh material.

12. An apparatus for attracting and holding rodents within a confined area, said apparatus comprising:
a cage formed from wire mesh material and having a cavity sufficient for holding a plurality of rodents therein, said cage including oppositely spaced end portions having a plurality of apertures formed therein for defining an entrance path into said cage respectively, said cage further including a top surface having an aperture formed therein for defining a path through which bait may be deposited into said cage, said cage further including a bottom surface including a door pivotally attached to said cage for allowing a user to access rodents trapped within said cage, said cage further including a plurality of trap doors pivotally connected to said cage and adjacent said opposed end portions for causing rodents to enter the cavity and become trapped therein as the rodents move towards the bait, said plurality of trap doors comprising
a plurality of outer end portions;
a plurality of spring members for connecting said plurality of outer end portions to said cage so that as rodents enter said apparatus through the entrance paths and move inwardly towards the bait said plurality of trap doors will pivot downwardly about said plurality of outer end portions thereof and thereafter pivot upwardly to a resting position after rodents enter the cavity; and
a plurality of stop members connected to said cage adjacent said plurality of trap doors and for preventing same from pivoting upwardly beyond a resting position.

13. The apparatus of claim 12, wherein the bait path defined by the top surface aperture is disposed in a substantially vertical direction medially of said opposed end portions of said cage so that bait can be positioned between the entrance paths.

14. The apparatus of claim 12, wherein the cavity is disposed below the entrance paths so that rodents cannot escape from the cavity after entering therein.

15. The apparatus of claim 12, further comprising:
a plurality of handles secured to said cage for assisting a user to transport same between remote locations.
